(19) United States
(12) Patent Application Publication
(10) Pub. No.: US 2021/0331273 A1
(43) Pub. Date: Oct. 28, 2021

(54) LASER PROCESSING APPARATUS AND METHODS OF LASER-PROCESSING WORKPIECES

(71) Applicant: ELECTRO SCIENTIFIC INDUSTRIES, INC., Portland, OR (US)

(72) Inventors: Daragh Finn, Portland, OR (US); Michael Kyslinger, Portland, OR (US)

(21) Appl. No.: 16/318,092

(22) PCT Filed: Jul. 21, 2017
(86) PCT No.: PCT/US2017/043229

§ 371 Date: Jan. 15, 2019

Related U.S. Application Data
(60) Provisional application No. 62/398,053, filed on Sep. 22, 2016.

(51) Int. Cl. B23K 26/0622; B23K 26/082; B23K 26/06; B23K 26/352

(52) U.S. Cl. CPC B23K 26/0624; B23K 26/082; B23K 2101/40; B23K 26/3576; B23K 26/0604

(57) ABSTRACT

A method of processing a workpiece having a first surface and a second surface opposite the first surface includes: generating a first beam of laser pulses having a pulse duration less than 200 ps at a pulse repetition rate greater than 500 kHz, directing the first beam of laser pulses along a beam axis intersecting the workpiece, and scanning the beam axis along a processing trajectory. The beam axis is scanned such that consecutively-directed laser pulses impinge upon the workpiece at a non-zero bite size to form a feature at the first surface of the workpiece. One or more parameters such as bite size, pulse duration, pulse repetition rate, laser pulse spot size and laser pulse energy is selected to ensure that the feature has a processed workpiece surface with a mean surface roughness (Ra) of less than or equal to 1.0 μm.

### CROSS-REFERENCE TO RELATED APPLICATIONS

This application claims the benefit of U.S. Provisional Application No. 62/368,053, filed Jul. 28, 2016, which is incorporated by reference in its entirety.

### BACKGROUND

### I. Technical Field

This disclosure relates generally to pulsed lasers and machining materials using high repetition rate pulsed lasers.

### II. Description of the Related Art

Several material processing applications including, for example, thin silicon wafer dicing, printed circuit board (PCB) drilling, solar cell manufacturing, and flat panel display manufacturing, involve similar material processing techniques and problems. Early solutions included mechanical and lithographic processing techniques. However, the reduction in device size, increased device complexity, and the environmental cost of chemical processing transitioned the industry toward laser processing methods. High power diode-pumped solid state lasers having typical wavelengths of 1 μm, or frequency converted versions having green or UV wavelengths, are now utilized. One method utilized in some applications includes progressively cutting through a workpiece with repetitive passes at relatively high scanning speeds. In such applications, there are three main problems: (a) generation and accumulation of debris at or near a processing site; (b) creation of a large heat-affected zone (HAZ); and (c) achieving a sufficiently high volume material removal rate to be commercially viable. As used herein, the term “debris” shall refer to workpiece material ejected from a processing site (in any of a solid, liquid or gaseous form) during laser processing, and is also commonly described using other terms such as recast, slag, redeposit, and the like. A HAZ refers to a region of the workpiece which has had its microstructure or other chemical, electrical or physical properties altered by the heat generated during the laser processing.

Various options have been suggested for efficient and high-quality laser-based machining of workpieces, including use of lasers to generate laser pulses having ultrashort pulse durations at high repetition rates, which generate less debris than laser pulses having relatively longer pulse widths, and create a relatively small HAZ in the workpiece. Nevertheless, techniques involving use of ultrashort laser pulses generated at high repetition rates still generate debris. In certain applications, accumulation of generated debris can be problematic if it produces an undesirably rough or uneven surface, if it creates undesirable stress concentrators, and the like.

Conventionally, accumulated debris can be removed by exposing the processed workpiece to a chemical etchant, by cleaning the processed workpiece in an ultrasonic bath (e.g., of DI water), or the like. The problem can also be addressed by coating the workpiece with a sacrificial layer of material, onto which generated debris is accumulated during laser processing, and which can be removed after laser processing is complete. However, such techniques reduce throughput and increase costs by adding additional processing steps and additional consumable materials. As such, a preferred solution would eliminate the need for such debris removal.

### SUMMARY

One embodiment of the present invention may be characterized as a method that includes providing a workpiece having a first surface and a second surface opposite the first surface, generating a first beam of laser pulses having a pulse duration less than 200 ps at a pulse repetition rate greater than 500 kHz, directing the first beam of laser pulses along a beam axis intersecting the workpiece, and scanning the beam axis along a processing trajectory. The beam axis is scanned such that consecutively-directed laser pulses impinge upon the workpiece at a non-zero bite size to form a feature at the first surface of the workpiece. One or more parameters such as bite size, pulse duration, pulse repetition rate, laser pulse spot size and laser pulse energy is selected to ensure that the feature has a processed workpiece surface with a mean surface roughness (Ra) of less than or equal to 1.0 μm.

In some embodiments, the pulse duration of the each of the laser pulses in the first beam of laser pulses is less than or equal to 1 ps, less than or equal to 800 fs, less than or equal to 750 fs, less than or equal to 700 fs, less than or equal to 650 fs, or less than or equal to 600 fs.

In some embodiments, the pulse repetition rate of laser pulses in the first beam of laser pulses is greater than 1200 kHz, greater than 1250 kHz, greater than 1300 kHz, greater than 1400 kHz, greater than 1500 kHz, greater than 1600 kHz, greater than 1700 kHz, greater than 1800 kHz, greater than 1900 kHz, greater than 2000 kHz, or greater than 3000 kHz.

In some embodiments, the mean surface roughness (Ra) is less than or equal to 0.75 μm, less than or equal to 0.5 μm, less than or equal to 0.4 μm, less than or equal to 0.3 μm, less than or equal to 0.25 μm, less than or equal to 0.2 μm, less than or equal to 0.15 μm, etc., or between any of these values.

In one embodiment, the method may be further characterized as including additionally acts of generating a generating a second beam of laser pulses (after the feature is formed at the first surface of the workpiece), focusing laser pulses within the second beam of laser pulses to produce a beam waist, directing the focused, second beam of laser pulses along a beam axis intersecting the processed workpiece surface such that the beam waist is arranged within the workpiece or at the second surface of the workpiece, and processing the workpiece at or near the beam waist. In one embodiment, the workpiece is more transparent to a wavelength of laser pulses within the second beam of laser pulses than to a wavelength of laser pulses within the first beam of laser pulses.

### BRIEF DESCRIPTION OF THE DRAWINGS

FIG. 1 schematically illustrates an apparatus for processing a workpiece, in accordance with one embodiment of the present invention.

FIGS. 2 and 3 illustrate photomicrographs (taken from a top plan view) of trenches formed in the surface of a silicon wafer.

FIG. 4 illustrates photomicrographs (taken from a top plan view) of laser-processed features, each of which includes a set of intersecting scribe lines formed in the surface of a silicon wafer.

FIG. 5 illustrates a set of graphs showing the relationship between mean surface roughness (Ra) of processed workpiece surfaces in trenches formed in a silicon wafer by propagating laser pulses along a scanned beam axis, at different pulse repetition rates, and material removal rate during the trench formation process, as a function of bit size and fluence.

FIG. 6 illustrates a set of graphs showing process windows for forming trenches in a silicon wafer that result in formation of processed workpiece surfaces with certain characteristics.

FIG. 7 illustrates a photomicrograph (taken from a side cross-sectional view) of a silicon wafer processed to form a trench in a manner that yields a smooth processed workpiece surface.

FIGS. 8A and 8B illustrate photomicrographs (taken from side cross-sectional views) of the processed silicon wafer shown in FIG. 7, after the silicon wafer has been further processed to form a trench cracks inside the silicon wafer. FIG. 8A shows a view across the width of the trench shown in FIG. 7. FIG. 8B shows a view along the length of the trench shown in FIG. 7.

FIGS. 9A-9D illustrate methods for processing a workpiece, according to some embodiments.

### DETAILED DESCRIPTION

Example embodiments are described herein with reference to the accompanying drawings. Unless otherwise expressly stated, in the drawings the sizes, positions, etc., of components, features, elements, etc., as well as any distances therebetween, are not necessarily to scale, but are exaggerated for clarity.

The terminology used herein is for the purpose of describing particular example embodiments only and is not intended to be limiting. As used herein, the singular forms “a,” “an” and “the” are intended to include the plural forms as well, unless the context clearly indicates otherwise. It should be recognized that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween. Unless indicated otherwise, terms such as “first,” “second,” etc., are only used to distinguish one element from another. For example, one node could be termed a “first node” and similarly, another node could be termed a “second node”, or vice versa. The section headings used herein are for organizational purposes only and are not to be construed as limiting the subject matter described.

Unless indicated otherwise, the term “about,” “thereabout,” etc., means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

Spatially relative terms, such as “below,” “beneath,” “lower,” “above,” and “upper,” and the like, may be used herein for ease of description to describe one element or feature's relationship to another element or feature, as illustrated in the FIGS. It should be recognized that the spatially relative terms are intended to encompass different orientations in addition to the orientation depicted in the FIGS. For example, if an object in the FIGS. is turned over, elements described as “below” or “beneath” other elements or features would then be oriented “above” the other elements or features. Thus, the exemplary term “below” can encompass both an orientation of above and below. An object may be otherwise oriented (e.g., rotated 90 degrees or at other orientations) and the spatially relative descriptors used herein may be interpreted accordingly.

Like numbers refer to like elements throughout. Thus, the same or similar numbers may be described with reference to other drawings even if they are neither mentioned nor described in the corresponding drawing. Also, even elements that are not denoted by reference numbers may be described with reference to other drawings.

It will be appreciated that many different forms and embodiments are possible without deviating from the spirit and teachings of this disclosure and so this disclosure should not be construed as limited to the example embodiments set forth herein. Rather, these examples and embodiments are provided so that this disclosure will be thorough and complete, and will convey the scope of the disclosure to those skilled in the art.

### I. OVERVIEW

Embodiments described herein relate generally to methods and apparatuses for laser-based machining (also referred to herein as laser-processing, laser processing, or, most simply, “processing,” of a workpiece. Generally the processing is accomplished, either in whole or in part, by irradiating the workpiece with laser radiation, to heat, melt, evaporate, ablate, crack, polish, etc., a workpiece. Specific examples of processes that may be carried by the illustrated apparatus include via drilling, scribing, dicing, engraving, etc. Thus, features that may be formed on or within workpieces, as a result of the processing, can include openings, vias (e.g., blind vias, through vias, slot vias), grooves, trenches, scribe lines, kerfs, recessed regions, or the like or any combination thereof.

Workpieces that may be processed can be generically characterized as metals, polymers, ceramics, or any combination thereof. Specific examples of workpieces that may be processed include, integrated circuits (ICs), IC packages (ICPs), light-emitting diodes (LEDs), LED packages, semiconductor wafers, electronic or optical device substrates (e.g., substrates formed of Al₂O₃, AlN, BeO, Cu, GaAs, GaN, Ge, InP, Si, SiO₂, SiC, Si₁₋ₓGeₓ (where 0.0001<x<0.9999), or the like, or any combination or alloy thereof), articles formed of plastic, glass (e.g., either unstrengthened, or strengthened thermally, chemically, or otherwise), quartz, sapphire, plastic, silicon, etc. Accordingly, materials that may be processed include one or more metals (e.g., Al, Ag, Au, Cu, Fe, In, Mg, Pt, Sn, Ti, or the like, or combinations or alloys thereof), conductive metal oxides (e.g., ITO, etc.), transparent conductive polymers, ceramics, waxes, resins, substrate materials (e.g., Al₂O₃, AN, BeO, Cu, GaAs, GaN, Ge, InP, Si, SiO₂, SiC, Si₁₋ₓGeₓ, or the like, or combinations or alloys thereof), inorganic dielectric materials (e.g., used as interlayer dielectric structures, such as silicon oxide, silicon nitride, silicon oxynitride, or the like or any combination thereof), low-k dielectric materials (e.g., methyl silsesquioxane (MSQ), hydrogen silsesquioxane (HSQ), fluorinated tetraethyl orthosilicate (FTEOS), or the like or any combination thereof), organic dielectric materials (e.g., SILK, benzocyclobutene, Nautilus, (all manufactured by Dow), polyfluorotetraethylene, (manufactured by DuPont), FLARE, (manufactured by Allied Chemical), or the like or any combination thereof), glass fibers, polymeric materials (polyamides, polyimides, polyesters, polyacetals, polycarbonates, modified polyphenylene ethers, polybutylene terephthalates, polyphenylene sulfides, polyether sulfones, polyether imides, polyether ether ketones, liquid crystal polymers, acrylonitrile butadiene styrene, and any compound, composite, or alloy thereof), or the like or any combination thereof.

### II. SYSTEM—OVERVIEW

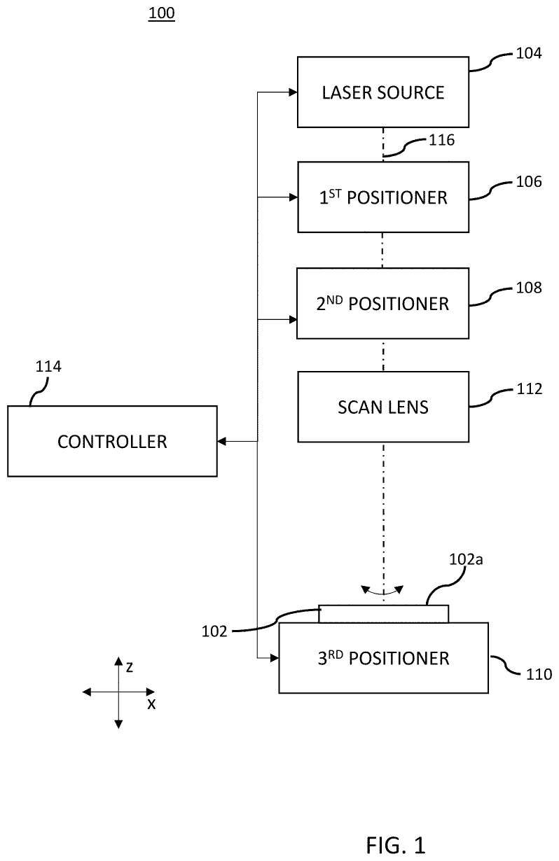

FIG. 1 schematically illustrates an apparatus for processing a workpiece, in accordance with one embodiment of the present invention.

Referring to the embodiment shown in FIG. 1, an apparatus 100 for processing a workpiece 102 includes a laser source 104 for generating laser pulses, a first positioner 106, a second positioner 108, a third positioner 110, a scan lens 112 and a controller 114. In view of the description that follows, it should be recognized that inclusion of the first positioner 106 is optional (i.e., the apparatus 100 need not include the first positioner 106), provided that the apparatus 100 includes the second positioner 108. Likewise, it should be recognized that inclusion of the second positioner 108 is optional (i.e., the apparatus 100 need not include the second positioner 108), provided that the apparatus 100 includes the first positioner 106. Lastly, it should similarly be recognized that inclusion of the third positioner 110 is optional (i.e., the apparatus 100 need not include the third positioner 108).

Although not illustrated, the apparatus 100 also includes one or more optical components (e.g., beam expanders, beam shapers, apertures, harmonic generation crystals, filters, collimators, lenses, mirrors, polarizers, wave plates, diffractive optical elements, or the like or any combination thereof) to focus, expand, collimate, shape, polarize, filter, split, combine, crop, or otherwise modify, condition or direct laser pulses generated by the laser source 104 along one or more beam paths (e.g., beam path 116) to the scan lens 112. It will further be appreciated that one or more of the aforementioned components may be provided, or that the apparatus 100 may further include additional components, as disclosed in U.S. Pat. Nos. 4,912,487, 5,633,747, 5,638,267, 5,751,585, 5,847,960, 5,917,300, 6,314,473, 6,430,465, 6,700,600, 6,706,998, 6,706,999, 6,816,294, 6,947,454, 7,019,891, 7,027,199, 7,133,182, 7,133,186, 7,133,187, 7,133,188, 7,245,412, 7,259,354, 7,611,745, 7,834,293, 8,026,158, 8,076,605, 8,158,493, 8,288,679, 8,404,998, 8,497,450, 8,648,277, 8,680,430, 8,847,113, 8,896,909, 8,928,853 or in aforementioned U.S. Patent App. Pub. Nos. 2014/0026351, 2014/0197140, 2014/0263201, 2014/0263212, 2014/0263223, 2014/0312013, or in German Patent No. DE102013201968B4, or in International Patent App. Pub. No. WO2009/087392, or any combination thereof, each of which is incorporated herein by reference in its entirety.

Laser pulses transmitted through the scan lens 112 propagate along a beam axis so as to be delivered to the workpiece 102. Laser pulses delivered to the workpiece 102 may be characterized as having a Gaussian or shaped (e.g., “top-hat”) spatial intensity profile. The spatial intensity profile can also be characterized as a cross-sectional shape of a laser pulse propagating along the beam axis (or beam path 116), which may be circular, elliptical, rectangular, triangular, hexagonal, ring-shaped, etc., or arbitrarily shaped. In addition, such delivered laser pulses can impinge the workpiece 102 at a spot size in a range from 2 μm to 200 μm. As used herein, the term “spot size” refers to the diameter or spatial width of a delivered laser pulse at a location where the beam axis traverses a region of the workpiece 102 (also referred to as a “processing site,” “process spot,” “spot location” or, more simply, a “spot”) that is to be processed by the delivered laser pulse. For purposes of discussion herein, spot size is measured as a radial or transverse distance from the beam axis to where the optical intensity drops to 1/e² of the optical intensity at the beam axis. Generally, the spot size of a laser pulse will be at a minimum at the beam waist. It will be appreciated, however, that the spot size can be made smaller than 2 μm or larger than 200 μm. Thus, at least one laser pulse delivered to the workpiece 102 can have a spot size less than, greater than or equal to 2 μm, 3 μm, 5 μm, 7 μm, 10 μm, 15 μm, 30 μm, 35 μm, 40 μm, 45 μm, 50 μm, 55 μm, 80 μm, 100 μm, 150 μm, 200 μm, etc., or between any of these values. In one embodiment, laser pulses delivered to the workpiece 102 can have a spot size in a range from 25 μm to 60 μm. In another embodiment, laser pulses delivered to the workpiece 102 can have a spot size in a range from 35 μm to 50 μm.

A. Laser Source

Generally, the laser source 104 is operative to generate laser pulses. As such, the laser source 104 may include a pulse laser source, a QCW laser source, or a CW laser source. In the event that the laser source 104 includes a QCW or CW laser source, the laser source 104 may further include a pulse gating unit (e.g., an acousto-optic (AO) modulator (AOM), a beam chopper, etc.) to temporally modulate beam of laser radiation output from the QCW or CW laser source. Although not illustrated, the apparatus 100 may optionally include one or more harmonic generation crystals (also known as “wavelength conversion crystals”) configured to convert a wavelength of light output by the laser source 104. Accordingly, laser pulses ultimately delivered to the workpiece 102 may be characterized as having one or more wavelengths in one or more of the ultra-violet (UV), visible (e.g., green), infrared (IR), near-IR (NIR), short-wavelength IR (SWIR), mid-wavelength IR (MWIR), or long-wavelength IR (LWIR) ranges of the electromagnetic spectrum, or any combination thereof.

Laser pulses output by the laser source 104 can have a pulse width or duration (i.e., based on the full-width at half-maximum (FWHM) of the optical power versus time) in a range from 30 fs to 500 ps. It will be appreciated, however, that the pulse duration can be made smaller than 10 fs or larger than 500 ps. Thus, at least one laser pulse output by the laser source 104 can have a pulse duration less than, greater than or equal to 10 fs, 15 fs, 30 fs, 50 fs, 75 fs, 100 fs, 150 fs, 200 fs, 300 fs, 500 fs, 700 fs, 750 fs, 800 fs, 850 fs, 900 fs, 1 ps, 2 ps, 3 ps, 4 ps, 5 ps, 7 ps, 10 ps, 15 ps, 25 ps, 50 ps, 75 ps, 100 ps, 200 ps, 500 ps, etc., or between any of these values. In one embodiment, laser pulses output by the laser source 104 have a pulse duration in a range from 10 fs to 1 ps. In another embodiment, laser pulses output by the laser source 104 have a pulse duration in a range from 500 fs to 900 fs.

Laser pulses output by the laser source 104 can have an average power in a range from 100 mW to 50 kW. It will be appreciated, however, that the average power can be made smaller than 100 mW or larger than 50 kW. Thus, laser pulses output by the laser source 104 can have an average power greater than or equal to 100 mW, 300 mW, 500 mW, 800 mW, 1 W, 2 W, 3 W, 4 W, 5 W, 6 W, 7 W, 10 W, 15 W, 25 W, 30 W, 50 W, 60 W, 100 W, 150 W, 200 W, 250 W, 500 W, 2 kW, 3 kW, 20 kW, 50 kW, etc., or between any of these values.

Laser pulses can be output by the laser source 104 at a pulse repetition rate in a range from 5 kHz to 1 GHz. It will be appreciated, however, that the pulse repetition rate can be less than 5 kHz or larger than 1 GHz. Thus, laser pulses can be output by the laser source 104 at a pulse repetition rate less than, greater than or equal to 5 kHz, 50 kHz, 100 kHz, 250 kHz, 500 kHz, 800 kHz, 900 kHz, 1 MHz, 1.5 MHz, 1.8 MHz, 1.9 MHz, 2 MHz, 2.5 MHz, 3 MHz, 4 MHz, 5 MHz, 10 MHz, 20 MHz, 50 MHz, 70 MHz, 100 MHz, 150 MHz, 200 MHz, 250 MHz, 300 MHz, 350 MHz, 500 MHz, 550 MHz, 700 MHz, 900 MHz, 2 GHz, 10 GHz, etc., or between any of these values. In some embodiments, the pulse repetition rate can be in a range from 1.5 MHz to 10 MHz.

In addition to wavelength, pulse duration, average power and pulse repetition rate, laser pulses delivered to the workpiece 102 can be characterized by one or more other characteristics such as pulse energy, peak power, etc., which can be selected based on one or more other parameters to irradiate the workpiece 102 at the process spot at an optical intensity (measured in W/cm²), fluence (measured in J/cm²), etc., sufficient to process the workpiece 102 or a component thereof, to form one or more features having one or more desired characteristics. Examples of such other parameters include one or more of the aforementioned characteristics such as wavelength, pulse duration, average power and pulse repetition rate, as well as material properties of the workpiece 102, bite size, desired processing throughput, or the like or any combination thereof. As used herein, the term “bite size” refers to the center-to-center distance between spot areas irradiated by consecutively-delivered laser pulses.

For example, laser pulses delivered to the workpiece 102 can have a pulse energy in a range from 1 μJ to 20 μJ. In one embodiment, any delivered laser pulse can have a pulse energy in a range from 2 μJ to 10 μJ. In another embodiment, any delivered laser pulse can have a pulse energy in a range from 3 μJ to 6 μJ. It will be appreciated, however, that the pulse energy of a delivered laser pulse can be less than 1 μJ or larger than 20 μJ. In another example, laser pulses delivered to the workpiece 102 can have a fluence in a range from 1 μJ to 20 μJ. In one embodiment, any delivered laser pulse can have a pulse energy in a range from 2 μJ to 10 μJ. In another embodiment, any delivered laser pulse can have a pulse energy in a range from 2 μJ to 6 μJ. It will be appreciated, however, that the pulse energy of a delivered laser pulse can be less than 1 μJ or larger than 20 μJ.

Examples of types of lasers that the laser source 104 may be characterized as gas lasers (e.g., carbon dioxide layers, carbon monoxide lasers, excimer lasers, etc.), solid-state lasers (e.g., Nd:YAG lasers, etc.), rod lasers, fiber lasers, photonic crystal rod/fiber lasers, passively mode-locked solid-state bulk or fiber lasers, dye lasers, mode-locked diode lasers, pulsed lasers (e.g., ms-, ns-, ps-, fs-pulsed lasers), CW lasers, QCW lasers, or the like or any combination thereof. Specific examples of laser sources that may be provided as the laser source 104 include one or more laser sources such as: the BOREAS, HEGOA, SIROCCO or CHINOOK series of lasers manufactured by EOLITE; the PYROFLEX series of lasers manufactured by PYROPHOTONICS; the PALADIN Advanced 355 or DIAMOND series lasers manufactured by COHERENT; the TRUFLOW-series of lasers (e.g., TRUFLOW 2000, 2700, 3200, 3600, 4000, 5000, 6000, 7000, 8000, 10000, 12000, 15000, 20000), or the TRUDISK-, TRUPULSE-, TRUDIODE-, TRUFIBER-, or TRUMICRO-series of lasers manufactured by TRUMPF; the FCPA μJEWEL or FEMTOLITE series of lasers manufactured by IMRA AMERICA; the TANGERINE and SATSUMA series lasers (and MIKAN and T-PULSE series oscillators) manufactured by AMPLITUDE SYSTEMES; CL-, CLPF-, CLPN-, CLPNT-, CLT-, ELM-, ELPF-, ELPN-, ELPP-, ELR-, ELS-, FLPN-, FLPNT-, FLT-, GLPF-, GLPN-, GLR-, HLPN-, HLPP-, RFL-, TLM-, TLPN-, TLR-, ULPN-, ULR-, VLM-, VLPN-, YLM-, YLPF-, YLPN-, YLPP-, YLR-, YLS-, FLPM-, FLPMT-, DLM-, BLM-, or DLR-series of lasers manufactured by IPG PHOTONICS (e.g., including the GPLN-100-M, GPLN-500-QCW, GPLN-500-M, GPLN-500-R, GPLN-2000-S, etc.), or the like or any combination thereof.

B. First Positioner

The first positioner 106, is disposed in the beam path 116 and is operative to diffract, reflect, refract, or the like, or any combination thereof, laser pulses that are generated by the laser source 104 so as to impart movement of the beam path 116 relative to the scan lens 112 and, consequently, movement of the beam axis relative to the workpiece 102. Generally, the first positioner 106 is configured to impart movement of the beam axis relative to the workpiece 102 along X- and Y-axes (or directions). Although not illustrated, the Y-axis (or Y-direction) will be understood to refer to an axis (or direction) that is orthogonal to the illustrated X- and Z-axes (or directions).

Movement of the beam axis relative to the workpiece 102, as imparted by the first positioner 106, is generally limited such that the process spot can be scanned, moved or otherwise positioned within a first scan field or “first scanning range” that extends between 0.01 mm to 4.0 mm in the X- and Y-directions. It will be appreciated, however, that the first scanning range may extend less than 0.01 mm or more than 4.0 mm in any of the X- or Y-directions (e.g., depending upon one or more factors such as the configuration of the first positioner 106, the location of the first positioner 106 along the beam path 116, the beam size of the laser pulses incident upon the first positioner 106, the spot size, etc.). Thus, the first scanning range may extend, in any of the X- and Y-directions a distance that is greater than or equal to 0.04 mm, 0.1 mm, 0.5 mm, 1.0 mm, 1.4 mm, 1.5 mm, 1.8 mm, 2 mm, 2.5 mm, 3.0 mm, 3.5 mm, 4.0 mm, 4.2 mm, etc., or between any of these values. As used herein, the term “beam size” refers to the diameter or width of a laser pulse, and can be measured as a radial or transverse distance from the beam axis to where the optical intensity drops to 1/e² of the optical intensity at the beam axis.

Generally, the bandwidth with which the first positioner 106 is capable of moving the beam axis, and thus positioning the process spot, (i.e., the first positioning bandwidth) is in a range from 50 kHz (or thereabout) to 10 MHz (or thereabout). Thus, the first positioner 106 is capable of positioning the process spot at any location within the first scanning range at a positioning rate (derived from the first positioning bandwidth) in a range from of one spot location per 20 μs (or thereabout) to one spot location per 0.1 μs (or thereabout). The inverse of the positioning rate is herein referred to as the “positioning period,” and refers to the period of time necessary to change the position the process spot from one location within the first scanning range to any other location within the first scanning range. Thus, the first positioner 106 can be characterized by a positioning period in a range from 20 μs (or thereabout) to 0.1 μs (or thereabout). In one embodiment, the first positioning bandwidth is in a range from 100 kHz (or thereabout) to 2 MHz (or thereabout). For example, the first positioning bandwidth of 1 MHz (or thereabout).

The first positioner 106 can be provided as a micro-electro-mechanical-system (MEMS) mirror or mirror array, an AO deflector (AOD) system, an electro-optic deflector (EOD) system, a fast-steering mirror (FSM) element incorporating a piezoelectric actuator, electrostrictive actuator, voice-coil actuator, etc., or the like or any combination thereof. In one embodiment, the first positioner 106 is provided as an AOD system including at least one (e.g., one, two, etc.) single-element AOD system, at least one (e.g., one, two, etc.) phased-array AOD system, or the like or any combination thereof. Both AOD systems include an AO cell formed of a material such as crystalline Ge, PbMoO₄, or TeO₂, glassy SiO₂, quartz, As₂S₃, etc., however the former includes a single ultrasonic transducer element acoustically coupled to the AO cell whereas the latter includes a phased-array of at least two ultrasonic transducers element commonly acoustically coupled to the AO cell.

Any of the AOD systems may be provided as a single-axis AOD system (e.g., configured impart movement of the beam axis along a single direction) or as a multi-axis AOD system (e.g., configured impart movement of the beam axis along multiple directions, e.g., X- and Y-directions) by deflecting the beam path 116. Generally, a multi-axis AOD system can be provided as a multi-cell system or a single-cell system. A multi-cell, multi-axis system typically includes multiple AOD systems, each configured to impart movement of the beam axis along a different axis. For example, a multi-cell, multi-axis system can include a first AOD system (e.g., a single-element or phased-array AOD system) configured to impart movement of the beam axis along the X-direction (e.g., an “X-axis AOD system”), and a second AOD system (e.g., a single-element or phased-array AOD system) configured to impart movement of the beam axis along the Y-direction (e.g., a “Y-axis AOD system”). A single-cell, multi-axis system (e.g., an “X/Y-axis AOD system”) typically includes a single AOD system configured to impart movement of the beam axis along the X- and Y-directions. For example, a single-cell system can include at least two ultrasonic transducers acoustically coupled to different planes, facets, sides, etc., of a common AO cell.

C. Second Positioner

Like the first positioner 106, the second positioner 108 is disposed in the beam path 116 and is operative to diffract, reflect, refract, or the like or any combination thereof, laser pulses that are generated by the laser source 104 and passed by the first positioner 106 so as to impart movement of the beam axis (e.g., along X- and Y-directions) relative to the workpiece 102, via movement of the beam path 116 relative to the scan lens 112. Movement of the beam axis relative to the workpiece 102, as imparted by the second positioner 108, is generally limited such that the process spot can be scanned, moved or otherwise positioned within a second scan field or “scanning range” that extends in the X- and/or Y-directions over an area that is greater than the first scanning range. In view of the configuration described herein, it should be recognized that movement of the beam axis imparted by the first positioner 106 can be superimposed by movement of the beam axis imparted by the second positioner 108. Thus, the second positioner 108 is operative to scan the first scanning range within the second scanning range.

In one embodiment, the second scanning range extends between 1 mm to 50 mm in the X- and/or Y-directions. It will be appreciated, however, that the second positioner 108 may be configured such that the second scanning range extends less than 1 mm or more than 50 mm in any of the X- or Y-directions. Thus in some embodiments, a maximum dimension of the second scanning range (e.g., in the X- or Y-directions, or otherwise) may be greater than or equal to a corresponding maximum dimension (as measured in the X-Y plane) of a feature (e.g., a via, a trench, a scribe line, a recessed region, a conductive trace, etc.) to be formed in the workpiece 102. In another embodiment however, the maximum dimension of the second scanning range may be less than the maximum dimension of the feature to be formed.

Generally, the bandwidth with which the second positioner 108 is capable of moving the beam axis, and thus positioning the process (and, thus, scanning the first scanning range within the second scanning range) (i.e., the second positioning bandwidth) is less than the first positioning bandwidth. In one embodiment, the second positioning bandwidth is in a range from 900 Hz to 5 kHz. In another embodiment, the first positioning bandwidth is in a range from 2 kHz to 3 kHz (e.g., about 2.5 kHz). For example, the second positioner 108 is provided as a galvanometer mirror system including two galvanometer mirror components, where one galvanometer mirror component is arranged to impart movement of the beam axis relative to the workpiece 102 along the X-direction and another galvanometer mirror component is arranged to impart movement of the beam axis relative to the workpiece 102 along the Y-direction. In other embodiments, however, the second positioner 108 may be provided as a rotating polygon mirror system, etc. It will thus be appreciated that, depending on the specific configuration of the second positioner 108 and the first positioner 106, the second positioning bandwidth may be greater than or equal to the first positioning bandwidth.

D. Third Positioner

The third positioner 110 is operative to impart movement of the workpiece 102 relative to the scan lens 112, and, consequently, movement of the workpiece 102 relative to the beam axis. Movement of the workpiece 102 relative to the beam axis is generally limited such that the process spot can be scanned, moved or otherwise positioned within a third scan field or “scanning range” that extends in the X- and/or Y-directions over an area that is greater than the second scanning range. In one embodiment, the third scanning range extends between 25 mm to 2 m in the X- and/or Y-directions. In another embodiment, the second scanning range extends between 0.5 m to 1.5 m in the X- and/or Y-directions. Generally, a maximum dimension of the third scanning range (e.g., in the X- or Y-directions, or otherwise) will be greater than or equal to a corresponding maximum dimension (as measured in the X-Y plane) of any feature to be formed in the workpiece 102. Optionally, the third positioner 110 may be configured to move the workpiece 102 relative to the beam axis within a scanning range that extends in the Z-direction (e.g., over a range between 1 mm and 50 mm). Thus, the third scanning range may extend along the X-, Y- and/or Z-directions.

In view of the configuration described herein, it should be recognized that movement of the beam axis imparted by the first positioner 106 and/or the second positioner 108 can be superimposed by movement of the workpiece 102 imparted by the third positioner 110. Thus, the third positioner 110 is operative to scan the first scanning range and/or second scanning range within the third scanning range. Generally, the bandwidth with which the third positioner 110 is capable of positioning the process spot (and, thus, scanning the first and/or second scanning ranges within the third scanning range) (i.e., the third positioning bandwidth) is less than the second positioning bandwidth (e.g., 10 Hz, or thereabout, or less).

In one embodiment, the third positioner 110 is provided as one or more linear stages (e.g., each capable of imparting translational movement to the workpiece 102 along the X-, Y- and/or Z-directions), one or more rotational stages (e.g., each capable of imparting rotational movement to the workpiece 102 about an axis parallel to the X-, Y- and/or Z-directions), or the like or any combination thereof. In one embodiment, the third positioner 110 includes an X-stage for moving the workpiece 102 along the X-direction, and a Y-stage supported by the X-stage (and, thus, moveable along the X-direction by the X-stage) for moving the workpiece 102 along the Y-direction. Although not shown, the apparatus 100 may include an optional chuck coupled to the third positioner 110, to which the workpiece 102 can be clamped, fixed, held, secured or be otherwise supported. Although not shown, the apparatus 100 may also include an optional base that supports the third positioner 110.

As described thus far, the apparatus 100 employs a so-called “stacked” positioning system, in which positions of the components such as the first positioner 106, second positioner 108, scan lens 112, etc., are kept stationary within the apparatus 100 (e.g., via one or more supports, frames, etc., as is known in the art) relative to the workpiece 102, which is moved via the third positioner 110. In another embodiment, the third positioner 110 may be arranged and configured to move one or more components such as the first positioner 106, second positioner 108, scan lens 112, etc., and the workpiece 102 may be kept stationary. In yet another embodiment, the apparatus 100 can employ a split-axis positioning system in which one or more components such as the first positioner 106, second positioner 108, scan lens 112, etc., are carried by one or more linear or rotational stages, and one or more linear or rotational stages arranged and configured to move the workpiece 102. Thus, the third positioner 110 imparts movement of the workpiece 102, as well as movement of one or more of the first positioner 106, second positioner 108, scan lens 112, etc. Some examples of split-axis positioning systems that may be beneficially or advantageously employed in the apparatus 100 include any of those disclosed in U.S. Pat. Nos. 5,751,585, 5,798,927, 5,847,960, 6,706,999, 7,605,343, 8,680,430, 8,847,113, or in U.S. Patent App. Pub. No. 2014/0083983, or any combination thereof, each of which is incorporated herein by reference in its entirety.

In another embodiment, one or more components such as the first positioner 106, second positioner 108, scan lens 112, etc., may be carried by an articulated, multi-axis robotic arm (e.g., a 2-, 3-, 4-, 5-, or 6-axis arm). In such an embodiment, the second positioner 108 and/or scan lens 112 may, optionally, be carried by an end effector of the robotic arm. In yet another embodiment, the workpiece 102 may be carried directly on an end effector of an articulated, multi-axis robotic arm (i.e., without the third positioner 110). In still another embodiment, the third positioner 110 may be carried on an end effector of an articulated, multi-axis robotic arm.

D. Scan Lens

The scan lens 112 (e.g., provided as either a simple lens, or a compound lens) is generally configured to focus laser pulses directed along the beam path, typically so as to produce a beam waist that can be positioned at the desired process spot. The scan lens 112 may be provided as an f-theta lens, a telecentric lens, an axicon lens (in which case, a series of beam waists are produced, yielding a plurality of process spots displaced from one another along the beam axis), or the like or any combination thereof.

E. Controller

Generally, the controller 114 is communicatively coupled (e.g., over one or more wired or wireless communications links, such as USB, Ethernet, Firewire, Wi-Fi, RFID, NFC, Bluetooth, Li-Fi, or the like or any combination thereof) to one or more components of the apparatus 100, such as the laser source 104, the first positioner 106, the second positioner 108, third positioner 110, the lens actuator, etc., and are thus operative in response to one or more control signals output by the controller 114.

For example, the controller 114 may control an operation of the first positioner 106, second positioner 108, or third positioner 110, to impart relative movement between the beam axis and the workpiece so as to cause relative movement between the process spot and the workpiece 102 along a trajectory (also referred to herein as a “process trajectory”) within the workpiece 102. It will be appreciated that any two of these positioners, or all three of these positioners, may be controlled such that two positioners (e.g., the first positioner 106 and the second positioner 108, the first positioner 106 and the third positioner 110, or the second positioner 108 and the third positioner 110), or all three positioners simultaneously impart relative movement between the process spot and the workpiece 102 (thereby imparting a “compound relative movement” between the beam axis and the workpiece). Of course, at any time, it is possible to control only one positioner (e.g., the first positioner 106, the second positioner 108 or the third positioner 110) to impart relative movement between the process spot and the workpiece 102 (thereby imparting a “non-compound relative movement” between the beam axis and the workpiece). Control signals to command compound or non-compound relative movement may be pre-computed, or otherwise determined in real-time.

Generally, the controller 114 includes one or more processors configured to generate the aforementioned control signals upon executing instructions. A processor can be provided as a programmable processor (e.g., including one or more general purpose computer processors, microprocessors, digital signal processors, or the like or any combination thereof) configured to execute the instructions. Instructions executable by the processor(s) may be implemented software, firmware, etc., or in any suitable form of circuitry including programmable logic devices (PLDs), field-programmable gate arrays (FPGAs), field-programmable object arrays (FPOAs), application-specific integrated circuits (ASICs)—including digital, analog and mixed analog/digital circuitry—or the like, or any combination thereof. Execution of instructions can be performed on one processor, distributed among processors, made parallel across processors within a device or across a network of devices, or the like or any combination thereof.

In one embodiment, the controller 114 includes tangible media such as computer memory, which is accessible (e.g., via one or more wired or wireless communications links) by the processor. As used herein, “computer memory” includes magnetic media (e.g., magnetic tape, hard disk drive, etc.), optical discs, volatile or non-volatile semiconductor memory (e.g., RAM, ROM, NAND-type flash memory, NOR-type flash memory, SONOS memory, etc.), etc., and may be accessed locally, remotely (e.g., across a network), or a combination thereof. Generally, the instructions may be stored as computer software (e.g., executable code, files, instructions, etc., library files, etc.), which can be readily authored by artisans, from the descriptions provided herein, e.g., written in C, C++, Visual Basic, Java, Python, Tel, Perl, Scheme, Ruby, etc. Computer software is commonly stored in one or more data structures conveyed by computer memory.

Although not shown, one or more drivers (e.g., RF drivers, servo drivers, line drivers, power sources, etc.) can be communicatively coupled to an input of one or more components such as the laser source 104, the first positioner 106, the second positioner 108, the third positioner 110, the lens actuator, etc. In one embodiment, each driver typically includes an input to which the controller 114 is communicatively coupled and the controller 114 is thus operative to generate one or more control signals (e.g., trigger signals, etc.), which can be transmitted to the input(s) of one or more drivers associated with one or more components of the apparatus 100. Thus, components such as the laser source 104, the first positioner 106, the second positioner 108, third positioner 110, the lens actuator, etc., are responsive to control signals generated by the controller 114.

In another embodiment, and although not shown, one or more additional controllers (e.g., component-specific controllers) may, optionally, be communicatively coupled to an input of a driver communicatively coupled to a components (and thus associated with the component) such as the laser source 104, the first positioner 106, the second positioner 108, the third positioner 110, the lens actuator, etc. In this embodiment, each component-specific controller can be communicatively coupled and the controller 114 and be operative to generate, in response to one or more control signals received from the controller 114, one or more control signals (e.g., trigger signals, etc.), which can then be transmitted to the input(s) of the driver(s) to which it is communicatively coupled. In this embodiment, a component-specific controller may be configured as similarly described with respect to the controller 114.

In another embodiment in which one or more component-specific controllers are provided, the component-specific controller associated with one component (e.g., the laser source 104) can be communicatively coupled to the component-specific controller associated with one component (e.g., the first positioner 106, etc.). In this embodiment, one or more of the component-specific controllers can be operative to generate one or more control signals (e.g., trigger signals, etc.) in response to one or more control signals received from one or more other component-specific controllers.

### III. EXPERIMENTAL RESULTS CONCERNING REMOVAL OF WORKPIECE MATERIAL

According to some embodiments, and as discussed in greater detail below, the apparatus 100 is provided with a laser source 104 configured to process a workpiece 102 by removing portions of the workpiece 102 to form one or more features (e.g., openings, slots, vias, grooves, trenches, scribe lines, kerfs, recessed regions, or the like or any combination thereof). A surface created as a result of the processing is hereinafter referred to as a “processed workpiece surface,” and can include a sidewall, a bottom surface, or the like or any portion or combination thereof. In these embodiments, material is removed from the workpiece 102 by delivering to the workpiece 102, at a high repetition rate, laser pulses having an ultrashort pulse duration.

Various studies have shown that laser material processing in the ultrashort-pulse regime (using laser pulses having a pulse duration less than a few 10's of ps) offers numerous advantages compared with longer pulses. The thermal impact of picosecond and femtosecond laser interactions is highly limited, confining laser energy dissipation to small optical penetration depths with minimal collateral damage. This precisely confined laser ‘heating’ minimizes the energy loss into the underlying bulk material, providing for an efficient and controllable ablation process. The ultrashort pulse duration further ensures that a significant portion of the laser energy is delivered to the workpiece 102 before the development of a significant ablation plume and/or plasma; such efficient energy coupling is not available with laser pulses of longer pulse duration because of plasma reflection, plasma and plume scattering, and plume heating. It is also generally known that, when ultrashort laser pulses are delivered at a high pulse repetition rate (i.e., above 100 kHz), heat generated by a laser pulse that was previously delivered to a process spot will not completely dissipate away from the spot, and at least some of the heat will be present in the workpiece 102 within the vicinity of the spot until when a next laser pulse is delivered. Accordingly, heat tends to accumulate heat within a region of the workpiece 102 near a previously-irradiated process spot, so that a consecutively-delivered laser pulse can be delivered to a heated region of the workpiece 102. When an ultrashort laser pulse is subsequently delivered to the heated region, the increased temperature can help to positively affect the laser-material interaction to enhance efficient material removal while helping to reduce the generation of debris.

However, the inventors have discovered that, within the ultrashort, high pulse repetition rate regime, certain parameters such as fluence, average power, pulse energy, bite size and spot size (as well as pulse repetition rate), and various combinations of two or more of these parameters, can influence the surface morphology of the processed workpiece surface and, in some cases, influence the generation of debris during processing. What follows below are examples of novel and unexpected relationships discovered in the course of the inventors' extensive experimental research. In these experiments, the material of the workpiece 102 being processed was not “transparent” (or was “nontransparent”) to the wavelength of light in the delivered laser pulses. In this context, a material is considered to be “nontransparent” if it has a linear absorption spectrum within a particular bandwidth of the delivered laser pulses, and a thickness, such that the percentage of light transmitted through the material (i.e., along the beam axis) is less than 99%, less than 97%, less than 95%, less than 90%, less than 75%, less than 50%, less than 25%, less than 15%, less than 10%, less than 5%, or less than 1%.

A. Relationship Between Bite Size and Debris Generation

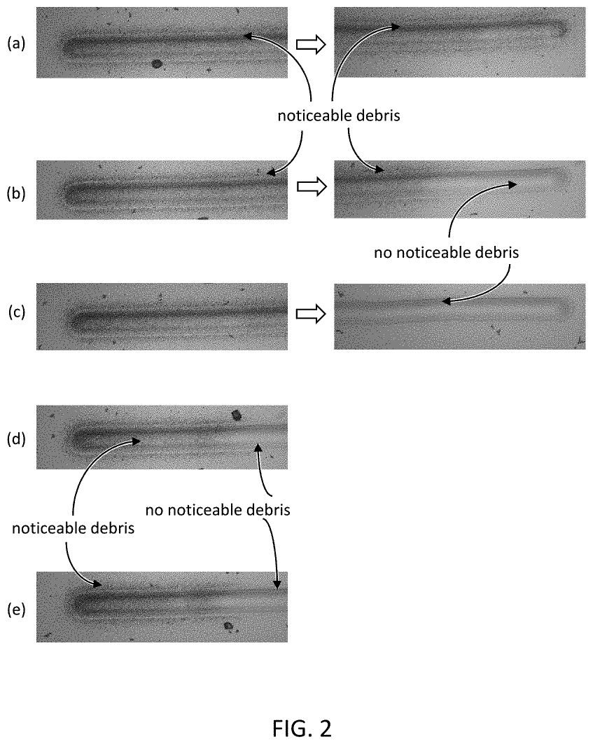

FIG. 2 illustrates photomicrographs (taken from a top plan view) of trenches (a) through (e) formed in the surface of a workpiece 102, provided here as a silicon wafer, in which laser pulses are delivered while causing relative movement between the beam axis and the workpiece 102, such that laser pulses are delivered along a process trajectory extending from left to right. The beginning end of each trench is thus shown in the left-illustrated column of photomicrographs, and the finishing ends of trenches (a) through (c) are shown in the right-illustrated column. The appearance of finishing ends of trenches (d) and (e) was substantially identical to the appearance of the finishing end of trench (c).

Each of trenches (a) through (e) was formed by propagating laser pulses having a spot size of 35 μm, a pulse duration of 800 fs, and a pulse energy of 6 μJ along the beam axis at a pulse repetition rate of 1855 kHz. Relative movement between the beam axis and the workpiece 102 was effected so as to cause consecutively-delivered laser pulses to impinge upon the workpiece 102 at a bite size of 0.5 μm for trench (a), a bite size of 0.475 μm for trench (b), a bite size of 0.5 μm for trench (c), a bite size of 0.425 μm for trench (d) and a bite size of 0.4 μm for trench (e). Trenches (a) through (e) were formed by scanning the delivered laser pulses along the process trajectory in a single pass.

As shown in FIG. 2, the parameters selected to form trench (a) resulted in the formation of significantly noticeable debris, both inside and outside the trench, resulting in a rough processed workpiece surface, as well as a rough workpiece surface outside the processed area along the edge of the trench. Upon decreasing the bite size from 0.5 μm to 0.475 μm, it is seen that the trench-formation process generates debris along most of the length of trench (b), but that no debris is detected at and near the end of the trench (b). It is estimated that about 850 μs elapsed, after formation of trench (b) was initiated, until generation of any noticeable debris ceased (i.e., the debris transition period was about 850 μs). Upon further decreasing the bite size to 0.45 μm, 0.425 μm, 0.4 μm during formation of trenches (c), (d) and (e), respectively, the debris transition period decreased to about 600 μs, about 320 μs and about 305 μs, respectively.

While not wishing to be bound by any particular theory, the inventors believe that the debris transition period decreases with decreasing bite size (while holding spot size, pulse duration, pulse energy and pulse repetition rate constant) because the spatial region in the workpiece, within which laser pulses are consecutively delivered, decreases. This allows regions within the workpiece 102 that locally-surround the irradiated process spots to accumulate heat. After the debris transition period has elapsed, the temperature of some of these regions (i.e., regions which are located along the process trajectory) remains elevated (i.e., between the melting temperature and the vaporization temperature of the material to be removed). The residual heat remaining within these regions of the workpiece 102 enables efficient ablation of material therein, without producing any noticeable debris.

B. Relationship Between Pulse Energy and Debris Generation

FIG. 3 illustrates photomicrographs (taken from a top plan view) of trenches (a) through (e) formed in the surface of a workpiece 102, provided here as a silicon wafer, in which laser pulses are delivered while causing relative movement between the beam axis and the workpiece 102, such that laser pulses are delivered along a process trajectory extending from left to right. Only the beginning end of each trench is shown.

Each of the trenches (a) through (e) was formed by propagating laser pulses having a spot size of 35 μm, a pulse duration of 800 fs, along the beam axis at a pulse repetition rate of 1979 kHz. Relative movement between the beam axis and the workpiece 102 was effected so as to cause consecutively-delivered laser pulses to impinge upon the workpiece 102 at a bite size of 0.5 μm, for each trench. Laser pulses delivered to the workpiece 102 had a pulse energy of 6 μJ during the formation of trench (a), a pulse energy of 5 μJ for trench (b), a pulse energy of 4 μJ for trench (c), a pulse energy of 3 μJ for trench (d) and a pulse energy of 2 μJ for trench (e). Trenches (a)-(e) were formed by scanning the delivered laser pulses along the processing trajectory in a single pass.

As shown in FIG. 3, the parameters selected to form trench (a) resulted in the formation of significantly noticeable debris near the beginning end outside the trench, resulting in a rough workpiece surface outside the processed area (less noticeable along the trench farther away from the beginning end), but a relatively smooth processed workpiece surface within the trench. Upon decreasing the pulse energy from 6 μJ to 5 μJ, it is seen that the trench-formation process generates significantly noticeable debris near the beginning end outside the trench (as well as noticeable debris along the trench farther away from the beginning end), resulting in a rough workpiece surface outside the processed area. The processed workpiece surface within trench (b) was observed to be less smooth than the processed workpiece surface within trench (a). Upon further decreasing the pulse energy to 4 μJ, the trench-formation process generates significantly noticeable debris in the beginning end of trench (c), resulting in a rough workpiece surface outside the processed area as well as rough processed workpiece surface within trench (c). Debris was also present along the longitudinal sides of trenches (a) through (c), in the form of a ridge of recast material from the beginning end to the finishing end. Upon further decreasing the pulse energy to 3 μJ, it is seen that the trench-formation process generates noticeable debris in and around the beginning end of trench (d), resulting in a rough workpiece surface outside the processed area as well as rough processed workpiece surface within trench (d); however, after a relatively short debris transition period, no noticeable debris generation was observed. The ridge of recast material also disappeared with increasing distance from the beginning end of trench (d). Upon further decreasing the pulse energy to 2 μJ, it is seen that the trench-formation process generates a very minor amount debris outside the trench (e) at or near the beginning end of trench (e), and no noticeable debris within the trench. Processed workpiece surfaces within the trench (e), however, appeared to be smooth, with no significant debris observed. No ridge of recast material was observed outside trench (e).

C. Effect of Scaling on Debris Generation

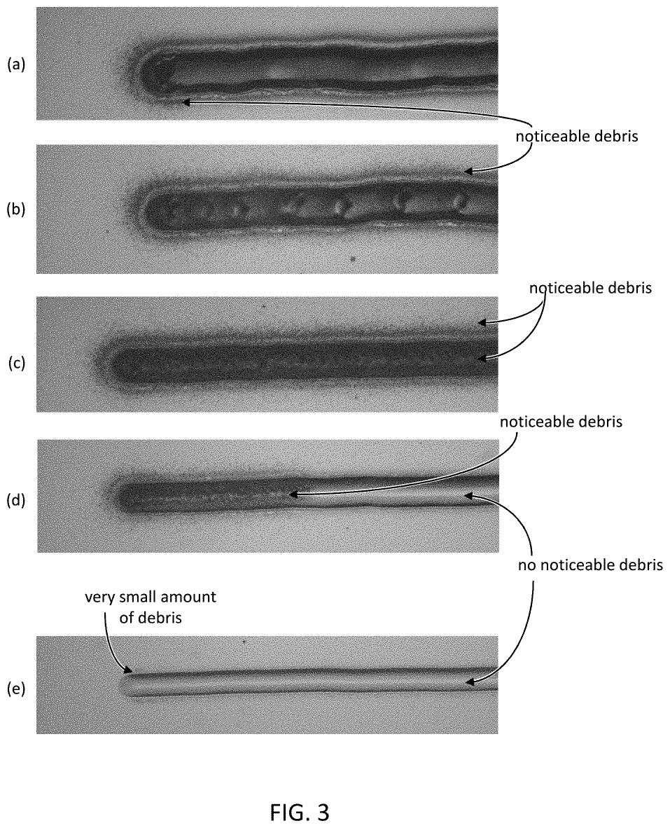

FIG. 4 illustrates photomicrographs (taken from a top plan view) of laser-processed features (a) and (b), each of which includes a set of intersecting scribe lines formed in the surface of a workpiece 102, provided here as a silicon wafer.

To form the features (a) and (b), laser pulses were delivered to the workpiece 102 while causing relative movement between the beam axis and the workpiece 102, such that laser pulses were delivered along a process trajectory including three parallel scan lines for each scribe line, and each scan line was addressed in a single pass. Each of features (a) and (b) was formed by propagating laser pulses having a pulse duration of 800 fs, along the beam axis at a pulse repetition rate of 1855 kHz. Laser pulses delivered to the workpiece 102 during formation of feature (a) had a spot size of 25 μm and a pulse energy of 3.14 μJ, and relative movement between the beam axis and the workpiece 102 was effected so as to cause consecutively-delivered laser pulses to impinge upon the workpiece 102 at a bite size of 0.1 μm. Laser pulses delivered to the workpiece 102 during formation of feature (b) had a spot size of 35 μm and a pulse energy of 6.16 μJ, and relative movement between the beam axis and the workpiece 102 was effected so as to cause consecutively-delivered laser pulses to impinge upon the workpiece 102 at a bite size of 0.25 μm.

As is evident from FIG. 4, a significant amount of debris was generated during the formation of feature (a), resulting in scribe lines having a rough processed workpiece surface, with visible pits and other damage. In contrast, substantially no debris was generated during the formation of feature (b), and the resulting scribe lines exhibited smooth processed workpiece surfaces with substantially no accumulated debris. Note: significant debris was generated and accumulated in the region of feature (b) enclosed by the dashed oval. This region corresponds to a region of the feature that was processed twice.

D. Relationship of Bite Size, Fluence and Pulse Repetition Rate with Surface Roughness and Material Removal Rate

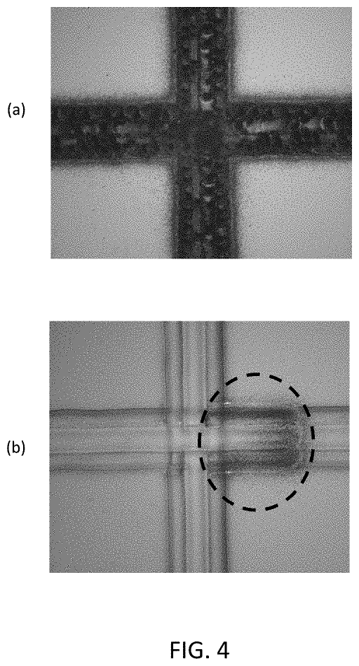

FIG. 5 illustrates a set of graphs showing the relationship between mean surface roughness (Ra) of processed workpiece surfaces in trenches formed in a workpiece 102, provided here as a silicon wafer, by propagating laser pulses along the beam axis at one of two pulse repetition rates (i.e., ˜927 kHz and ˜1855 kHz) while scanning delivered laser pulses along a processing trajectory in a single pass, and material removal rate (um2-Area) during the trench formation process, as a function of bit size (measured in μm) and fluence (measured in J/cm²). Mean surface roughness (Ra) was measured using a Keyence 3D confocal microscope with a 50× objective.

As is evident from FIG. 5, at bite sizes greater than 0.2 μm, the mean surface roughness of the processed workpiece surface drops below about 0.25 μm, approaching a mirror-smooth surface finish. The mean surface roughness of processed workpiece surfaces formed using laser pulses delivered at a pulse repetition rate of ˜1855 kHz are generally lower than corresponding processed workpiece surfaces formed using laser pulses delivered at a pulse repetition rate of ˜927 kHz, for all tested bite sizes and fluence levels. The um2-Area values represent the cross-sectional area of the scribes, and show that the material removal rate decreases with increasing bite size. Material removal rates attained during formation of trenches at the ˜927 kHz pulse repetition rate are similar to material removal rates attained during formation of trenches at the ˜1855 kHz pulse repetition rate.

E. Relationship of Bite Size, Fluence, Pulse Repetition Rate and Average Power with Debris Generation

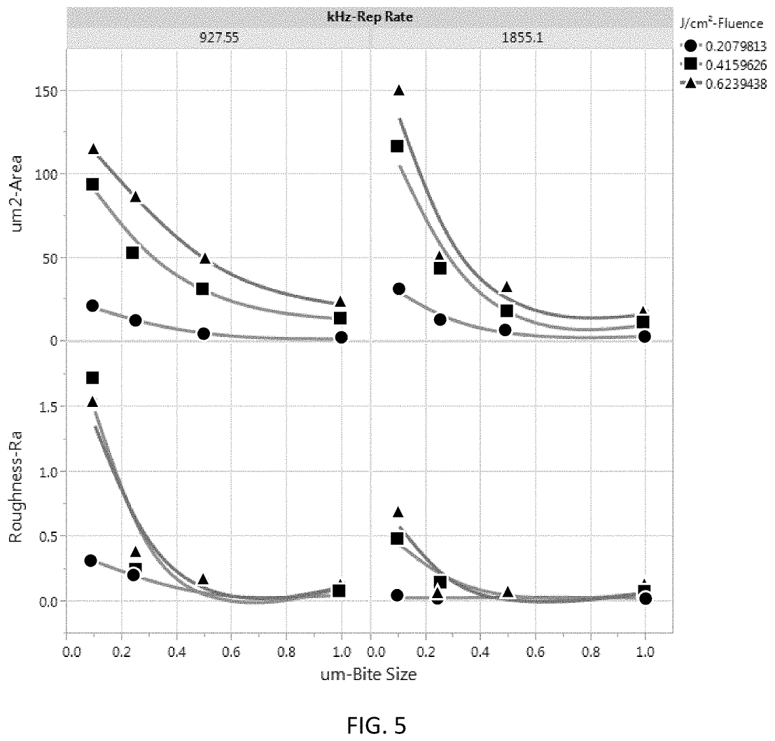

FIG. 6 illustrates a set of graphs showing process windows for forming trenches in a workpiece 102, provided here as a silicon wafer, which: i) result in formation of processed workpiece surfaces with no noticeable generation of debris (i.e., resulting in processed workpiece surfaces having no noticeable debris accumulated thereon, as discussed with respect to FIGS. 2 to 5); and ii) result in formation of processed workpiece surfaces with noticeable generation of debris (i.e., resulting in processed workpiece surfaces having noticeable debris accumulated thereon, as discussed with respect to FIGS. 2 to 5). Regions marked with the pattern indicated by reference numeral 600 represent a parameter space that results in generation of noticeable debris and regions marked with the pattern indicated by reference numeral 602 represent a parameter space that results in generation of no noticeable debris. The trenches observed were formed by propagating laser pulses along the beam axis at one of five pulse repetition rates (i.e., 927.55 kHz, 1264 kHz, 1855 kHz, 2022 kHz and 3051 kHz) while scanning delivered laser pulses along a processing trajectory in a single pass. At each pulse repetition rate, multiple trenches were formed, with each trench formed using a different combination of bite size (measured in μm), fluence (measured in J/cm²) and average power (measured in W).

As shown in FIG. 6, at 927.55 kHz and 1264 kHz, all combination of tested bite size, fluence and average power values were observed to generate a moderate to significant amount of debris whereas, at 1855 kHz, 2022 kHz and 3051 kHz, some (but not all) combinations of parameter values were found to yield processed workpiece surfaces with little to no accumulated debris. This finding tends to indicate that, for a particular material to be processed, there is a threshold pulse repetition rate below which debris generation cannot be avoided. However, above the threshold pulse repetition rate, some other general observations can be made: at relatively low fluence or average power values, the workpiece 102 can be processed using a relatively wide range of bite sizes to form features without generating moderate or significant amounts of debris; and as the fluence or average power increases, this range of bite sizes decreases.

There are some parameter spaces where the regions 600 and 602 overlap. See, e.g., the regions marked by patterns indicated by reference numeral 604. This overlap can be generally understood to indicate: (1) that there is a transition between significant or noticeable debris generation and insignificant or non-noticeable debris generation; or (2) that for a given fluence, power and bite size, there are processes that can produce either a clean, smooth feature or a feature accompanied by the generation of debris. As an example, at 1855 kHz, for processes matching the power and fluence, there is combination of spot size and pulse energy that produces different results (i.e., either a clean, smooth feature or a feature accompanied by the generation of debris). Stated another way, at a given coordinate within a parameter space where the regions 600 and 602 overlap, a feature having either a clean, smooth surface or a feature accompanied by the generation of debris can be formed, depending upon the spot size and pulse energy of the delivered laser pulses.

### IV. EXAMPLE EMBODIMENTS BASED UPON EXPERIMENTAL RESULTS

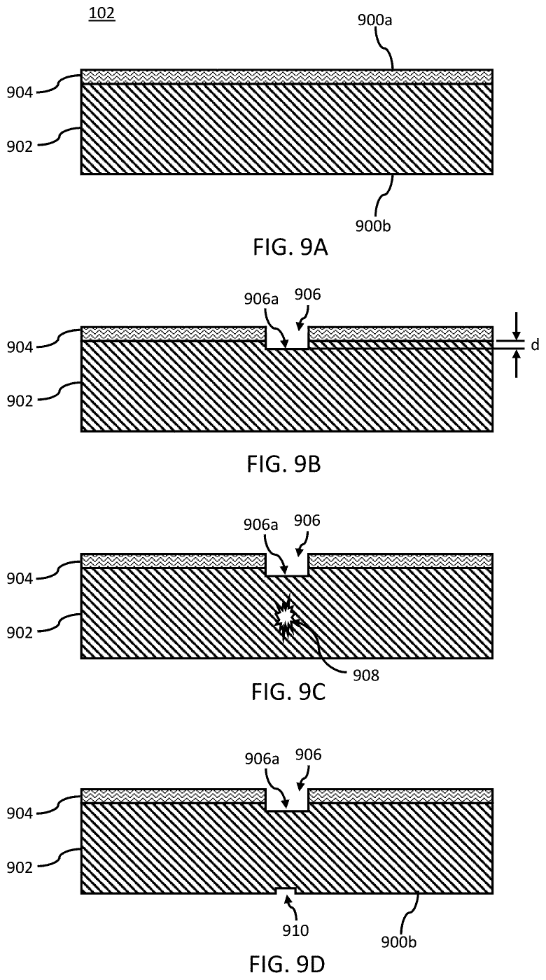

Based on results of experiments described above in Section III., sub-sections A. to E., one embodiment of the invention can be characterized as a laser process for forming a feature (e.g., a scribe or other trench or recess, etc.) in a workpiece 102 by removing material (which is nontransparent to the wavelength of light in the laser pulses delivered to the workpiece 102) during a removal process. For example, and with reference to the embodiment illustrated in FIG. 9A, a workpiece 102 may be provided as a semiconductor wafer having an upper surface (e.g., surface 900a) and a lower surface (e.g., surface 900b) opposite the upper surface. The semiconductor wafer may include a substrate 902 (e.g., formed of a material such as silicon, germanium, Si₁₋ₓGeₓ (where 0.0001<x<0.9999), GaAs, GaN, InP, or the like or any combination thereof) and a device layer 904 (e.g., formed of one or more field effect transistors, dielectric layers, interconnect metallization structures, passivation layers, or the like or any combination thereof). It should be recognized that the workpiece 102 can be provided in any manner other than the semiconductor wafer discussed above. For example, the workpiece 102 can be provided as any single- or multi-layered structure including a substrate (e.g., an electronic substrate, a semiconductor substrate, an optical substrate, etc.) formed of Al₂O₃, AN, BeO, Cu, GaAs, GaN, Ge, InP, Si, SiO₂, SiC, Si₁₋ₓGeₓ (where 0.0001<x<0.9999), or the like, or any combination or alloy thereof), an article formed of plastic, glass (e.g., either unstrengthened, or strengthened thermally, chemically, or otherwise), quartz, sapphire, plastic, silicon, etc., one or more metals (e.g., Al, Ag, Au, Cu, Fe, In, Mg, Pt, Sn, Ti, or the like, or combinations or alloys thereof), conductive metal oxides (e.g., ITO, etc.), transparent conductive polymers, ceramics, waxes, resins, inorganic dielectric materials (e.g., used as interlayer dielectric structures, such as silicon oxide, silicon nitride, silicon oxynitride, or the like or any combination thereof), low-k dielectric materials (e.g., methyl silsesquioxane (MSQ), hydrogen silsesquioxane (HSQ), fluorinated tetraethyl orthosilicate (FTEOS), or the like or any combination thereof), organic dielectric materials (e.g., SILK, benzocyclobutene, Nautilus, (all manufactured by Dow), polyfluorotetraethylene, (manufactured by DuPont), FLARE, (manufactured by Allied Chemical), or the like or any combination thereof), glass fibers, polymeric materials (polyamides, polyimides, polyesters, polyacetals, polycarbonates, modified polyphenylene ethers, polybutylene terephthalates, polyphenylene sulfides, polyether sulfones, polyether imides, polyether ether ketones, liquid crystal polymers, acrylonitrile butadiene styrene, and any compound, composite, or alloy thereof), or the like or any combination thereof.

Parameters of the removal process (e.g., one or more of fluence, average power, pulse repetition rate, pulse energy, spot size, bite size, etc.) are selected, controlled or otherwise set to ensure that portions of the workpiece 102 are removed in a manner to advantageously achieve one or more of the following: minimal or zero generation of debris during processing; creation of a smooth processed workpiece surface; creation of a processed workpiece surface having a reduced number of defects, flaws or cracks; creation of a uniform HAZ in the workpiece 102 adjacent to the processed workpiece surface. For example, during the removal process, a beam of beam of laser pulses may be directed along a beam axis that intersects the workpiece 102, and the beam of laser pulses may be scanned such that consecutively-directed laser pulses impinge upon the workpiece 102 at a non-zero bite size, to form a feature (e.g., feature 906, as shown in FIG. 9B, which may be recess, trench, etc.) at the upper surface 900a of the workpiece 102.

In the embodiment illustrated in FIG. 9B, the feature 906 extends completely through the device layer 904 and partially into the substrate 902 (e.g., to a depth, d, as measured from the upper surface of the substrate 902). In some embodiments, the depth, d, may be in a range from 5 μm (or thereabout) to 22 μm (or thereabout). For example, the depth, d, may be 5 μm, 5.5 μm, 6.0 μm, 6.5 μm, 7.0 μm, 7.5 μm, 8.0 μm, 8.5 μm, 10 μm, 12 μm, 15 μm, 17 μm, 20 μm, 22 μm, etc., or between any of these values. It should be recognized that the depth, d, may nevertheless be less than 5 μm or greater than 22 μm. In another embodiment, the feature 906

If parameters are selected to yield a processed workpiece surface (e.g., processed workpiece surface 906) that is sufficiently smooth, the processed workpiece surface may be used to facilitate subsequent processes such as internal processing of the workpiece 102, through-workpiece processing of the workpiece 102, or the like or any combination thereof. A processed workpiece surface (e.g., processed workpiece surface 906) can be considered “sufficiently smooth” to facilitate the subsequent processes if the processed workpiece surface has a mean surface roughness (Ra) of less than or equal to 1.0 μm. In some embodiments, the processed workpiece surface has a mean surface roughness (Ra) of less than 1.0 μm, less than 0.75 μm, less than 0.5 μm, less than 0.4 μm, less than 0.3 μm, less than 0.25 μm, less than 0.2 μm, less than 0.15 μm, etc., or between any of these values.

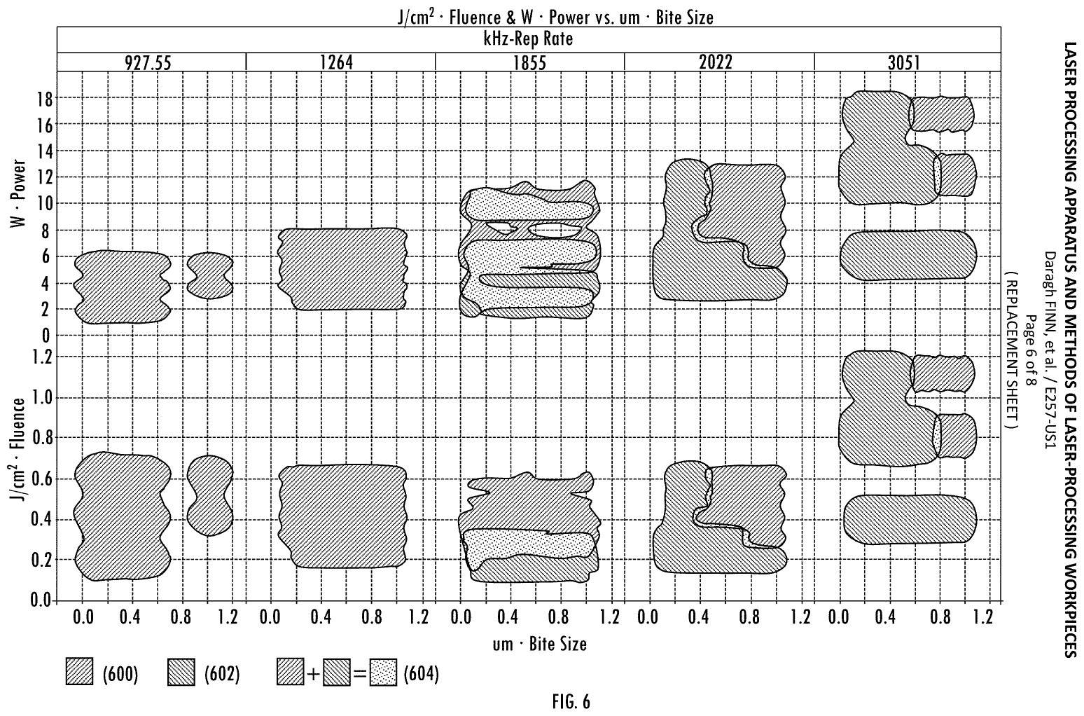

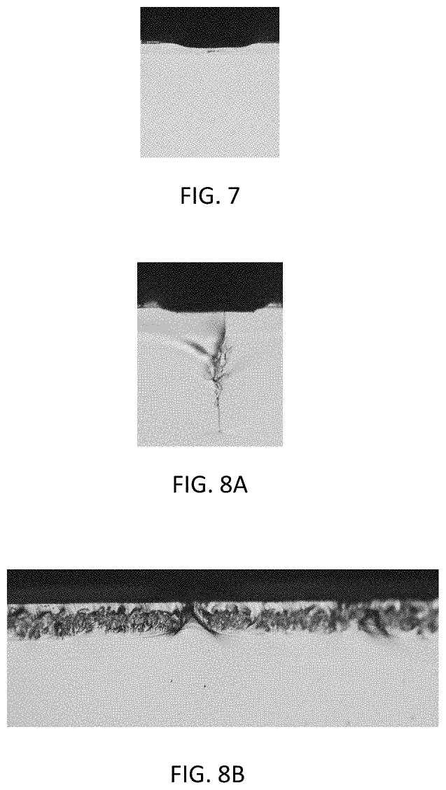

Internal processing of the workpiece 102 can be carried out by directing another beam of laser pulses so as to initially pass through the processed workpiece surface and, thereafter into the workpiece. In this case, the directed beam of laser pulses is focused such that the beam waist of the laser pulses is located inside the workpiece 102. Laser pulses used during internal processing of the workpiece 102 have a wavelength that is more transparent to material within the workpiece 102 being processed than the wavelength used during initial formation of the processed workpiece surface. Parameters associated with such internal processing (e.g., one or more of fluence, average power, pulse repetition rate, pulse energy, spot size, bite size, etc.) are selected to induce nonlinear absorption of the directed laser pulses by the material within the workpiece 102 to thereby process (e.g., melt, evaporate, ablate, crack, discolor, or the like, or otherwise modify one or more properties or characteristics such as chemical composition, crystal structure, electronic structure, microstructure, nanostructure, density, viscosity, index of refraction, magnetic permeability, relative permittivity, etc.) a portion of the material within the workpiece 102 (e.g., portion 908, as shown in FIG. 9C) that is at or near the beam waist of the delivered laser pulses. For example, after a trench has been formed in a workpiece 102 such as a silicon wafer, to yield a sufficiently smooth processed workpiece surface (e.g., as shown in the photomicrograph of FIG. 7), internal processing can be carried out as described above to form a series of cracks inside the silicon wafer (e.g., as shown in the photomicrographs of FIGS. 8A and 8B, where FIG. 8A shows a view across the width of the trench shown in FIG. 7 and FIG. 8B shows a view along the length of the trench shown in FIG. 7).

Referring to FIG. 9D, through-workpiece processing of the workpiece 102 can be carried out by directing another beam of laser pulses so as to initially pass through the processed workpiece surface (e.g., processed workpiece surface 906a) and, thereafter into the workpiece. The directed beam of laser pulses is focused such that the beam waist of the laser pulses is located at or near the lower surface 900b of the workpiece 102. Laser pulses used during internal processing of the workpiece 102 have a wavelength that is more transparent to material within the workpiece 102 being processed than the wavelength used during initial formation of the processed workpiece surface. Parameters associated with such through-workpiece processing (e.g., one or more of fluence, average power, pulse repetition rate, pulse energy, spot size, bite size, etc.) are selected to induce linear or nonlinear absorption of the directed laser pulses by the material of the workpiece 102 at the lower surface 900b to thereby process a portion of the workpiece 102 that is at or near the beam waist of the delivered laser pulses (e.g., to form a trench or recess 910 at the lower surface 900b). Some examples of through-workpiece processing of the workpiece 102 that may be performed is described in U.S. Pat. No. 9,610,653, which is incorporated herein by reference in its entirety.

### V. CONCLUSION

The foregoing is illustrative of embodiments and examples of the invention, and is not to be construed as limiting thereof. Although a few specific embodiments and examples have been described with reference to the drawings, those skilled in the art will readily appreciate that many modifications to the disclosed embodiments and examples, as well as other embodiments, are possible without materially departing from the novel teachings and advantages of the invention.

For example, although the experiments discussed above in Section III. were performed on bare silicon wafers, it should be recognized that similar effects can be observed when processing workpieces containing materials (other than silicon wafers) using ultrashort laser pulses, provided that the material to be processed is nontransparent relative to the wavelength of the delivered laser pulses. Thus, it should be recognized that the aforementioned embodiments can be beneficially adapted to process semiconductor wafers formed of materials other than silicon, electronic or optical device substrates (e.g., substrates formed of Al₂O₃, AN, BeO, Cu, GaAs, GaN, Ge, InP, Si, SiO₂, SiC, Si₁₋ₓGeₓ (where 0.0001<x<0.9999), or the like, or any combination or alloy thereof), articles formed of plastic, glass (e.g., either unstrengthened, or strengthened thermally, chemically, or otherwise), quartz, sapphire, plastic, silicon, etc., one or more metals (e.g., Al, Ag, Au, Cu, Fe, In, Mg, Pt, Sn, Ti, or the like, or combinations or alloys thereof), conductive metal oxides (e.g., ITO, etc.), transparent conductive polymers, ceramics, waxes, resins, inorganic dielectric materials (e.g., used as interlayer dielectric structures, such as silicon oxide, silicon nitride, silicon oxynitride, or the like or any combination thereof), low-k dielectric materials (e.g., methyl silsesquioxane (MSQ), hydrogen silsesquioxane (HSQ), fluorinated tetraethyl orthosilicate (FTEOS), or the like or any combination thereof), organic dielectric materials (e.g., SILK, benzocyclobutene, Nautilus, (all manufactured by Dow), polyfluorotetraethylene, (manufactured by DuPont), FLARE, (manufactured by Allied Chemical), or the like or any combination thereof), glass fibers, polymeric materials (polyamides, polyimides, polyesters, polyacetals, polycarbonates, modified polyphenylene ethers, polybutylene terephthalates, polyphenylene sulfides, polyether sulfones, polyether imides, polyether ether ketones, liquid crystal polymers, acrylonitrile butadiene styrene, and any compound, composite, or alloy thereof), or the like or any combination thereof.

Accordingly, all such modifications are intended to be included within the scope of the invention as defined in the claims. For example, skilled persons will appreciate that the subject matter of any sentence, paragraph, example or embodiment can be combined with subject matter of some or all of the other sentences, paragraphs, examples or embodiments, except where such combinations are mutually exclusive. The scope of the present invention should, therefore, be determined by the following claims, with equivalents of the claims to be included therein.

1. A method, comprising:
providing a workpiece having a first surface and a second surface opposite the first surface;
generating a first beam of laser pulses having a pulse duration less than 200 ps at a pulse repetition rate greater than 500 kHz, a spot size and a pulse energy; and
directing the first beam of laser pulses along a beam axis intersecting the workpiece;
scanning the beam axis along a processing trajectory, such that consecutively-directed laser pulses impinge upon the workpiece at a non-zero bite size, to form a feature at the first surface of the workpiece, and such that the feature is characterized as having a processed workpiece surface having a mean surface roughness (Ra) of less than 1.0 μm.

2. The method of claim 1, wherein the pulse duration is less than or equal to 1 ps.

3. The method of claim 2, wherein the pulse duration is less than or equal to 800 fs.

4. The method of claim 1, wherein the pulse repetition rate is greater than 1264 kHz.

5. The method of claim 4, wherein the pulse repetition rate is greater than or equal to 1800 kHz.

6. The method of claim 1, wherein the pulse repetition rate is greater than or equal to 1900 kHz.

7. The method of claim 6, wherein the pulse repetition rate is greater than or equal to 2000 kHz.

8. The method of claim 7, wherein the pulse repetition rate is greater than or equal to 3000 kHz.

9. The method of claim 1, wherein the mean surface roughness (Ra) is less than 0.75 μm.

10. The method of claim 1, wherein the mean surface roughness (Ra) is less than 0.5 μm.

11. The method of claim 10, wherein the mean surface roughness (Ra) is less than 0.4 μm.

12. The method of claim 11, wherein the mean surface roughness (Ra) is less than 0.3 μm.

13. The method of claim 12, wherein the mean surface roughness (Ra) is less than 0.25 μm.

14. The method of claim 1, further comprising:
generating a second beam of laser pulses;
focusing laser pulses within the second beam of laser pulses to produce a beam waist;
directing the focused, second beam of laser pulses along a beam axis intersecting the processed workpiece surface such that the beam waist is arranged within the workpiece or at the second surface of the workpiece; and
processing the workpiece at the beam waist.

15. The method of claim 14, wherein the workpiece is more transparent to a wavelength of laser pulses within the second beam of laser pulses than to a wavelength of laser pulses within the first beam of laser pulses.
